(19) United States
(12) Patent Application Publication
(10) Pub. No.: US 2001/0013518 A1
(43) Pub. Date: Aug. 16, 2001

(54) Paint tray with roller-holding means

(76) Inventors: Frederic Lallement, La Capelle (FR); Pascal Fievet, La Capelle (FR)

Correspondence Address: JACOBSON HOLMAN PLLC, 400 SEVENTH STREET N.W., SUITE 600, WASHINGTON, DC, 20004, US

(21) Appl. No.: 09/768,792

(22) Filed: Jan. 25, 2001

(30) Foreign Application Priority Data
Jan. 25, 2000 (FR) 00/00902

(51) Int. Cl. B05C 21/00

(52) U.S. Cl. 220/570

(57) ABSTRACT

The invention provides a paint tray for a paint roller, the tray comprising a paint pan and holding arrangements for a roller comprising a handle and a rotary roller proper, the holding arrangements being provided to hold the roller in a selected position in which at least the lowest portion of the roller proper is in a position to drip into the paint pan, wherein the holding arrangements are designed to co-operate essentially with the handle of the roller.

The present invention relates to paint trays for applicator rollers.

### BACKGROUND OF THE INVENTION

Such trays are generally rectangular and typically comprise a sloping wall which goes down to a trough containing paint.

After the roller has been dipped in the paint, the slope serves to spread the paint uniformly over the roller. Excess paint runs down the slope and back into the paint trough.

Proposals are made in document FR 2 322 754 to fit one edge of the tray with a series of vertical pegs, each serving to hold a roller that is engaged thereon vertically.

Proposals have also been made in document U.S. Pat. No. 4,025,205 to fit a side wall of the tray with an element that is specially designed to hold the roller in a position where the roller proper extends horizontally over the paint.

Although such an arrangement presents the advantage that the roller drips into the tray and not outside it or onto the handle, it nevertheless suffers from drawbacks. The holding element must carry the roller in a substantially horizontal position over the paint while bearing against it in highly localized manner. To be able to do this, such an element must be particularly strong and relatively undeformable, which is difficult to achieve in practice.

### OBJECT AND SUMMARY OF THE INVENTION

The invention sets out to resolve those drawbacks, i.e. to propose a tray having a roller-holding arrangement which enables the roller to drip into the tray while supporting the roller in a manner that is stable and robust.

The invention achieves this object by a paint tray for a paint roller, the tray comprising a paint pan and holding arrangements for a roller comprising a handle and a rotary roller proper, the holding arrangements being provided to hold the roller in a selected position in which at least the lowest portion of the roller proper is in a position to drip into the paint pan, wherein the holding arrangements are designed to co-operate essentially with the handle of the roller.

### BRIEF DESCRIPTION OF THE DRAWINGS

Other characteristics, objects, and advantages of the invention will appear more clearly on reading the following detailed description given with reference to the accompanying figures, in which:

FIG. 1 is a plan view of a tray of the invention;

FIG. 2 is a longitudinal section view of the tray;

FIG. 3 is a cross-section view of the tray on a plane A-A marked in FIG. 2;

FIG. 4 is a cross-section through the tray on a plane B-B marked in FIG. 2;

FIG. 5 is a section view showing the scraping arrangement provided on the tray; and

FIG. 6 is a longitudinal section through the tray provided with a roller that is shown in part.

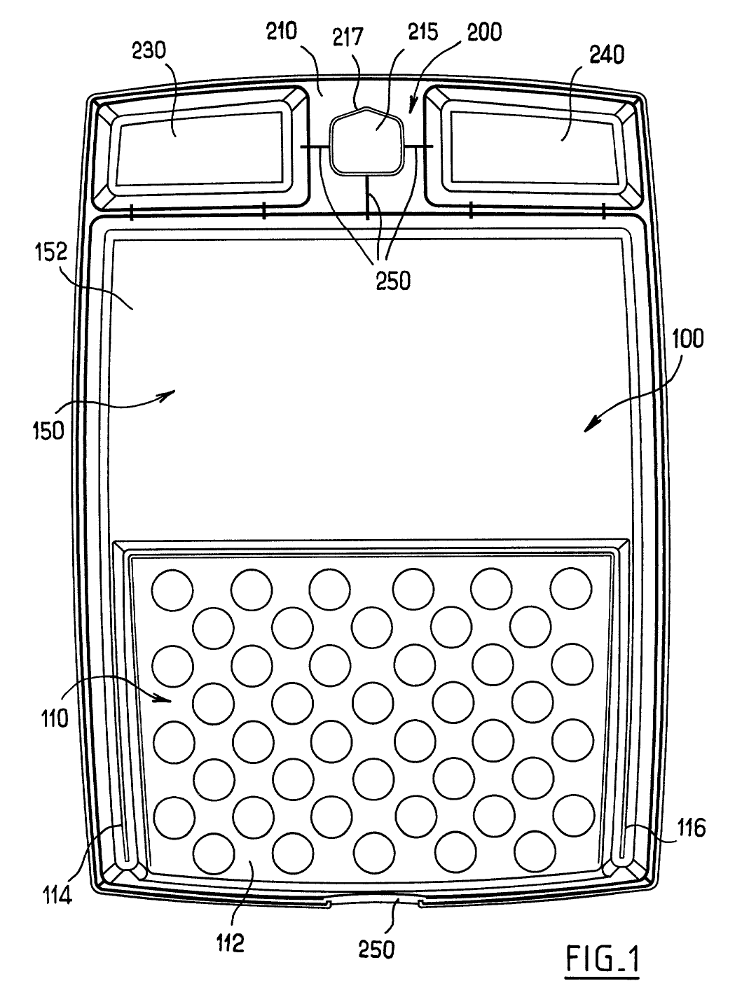

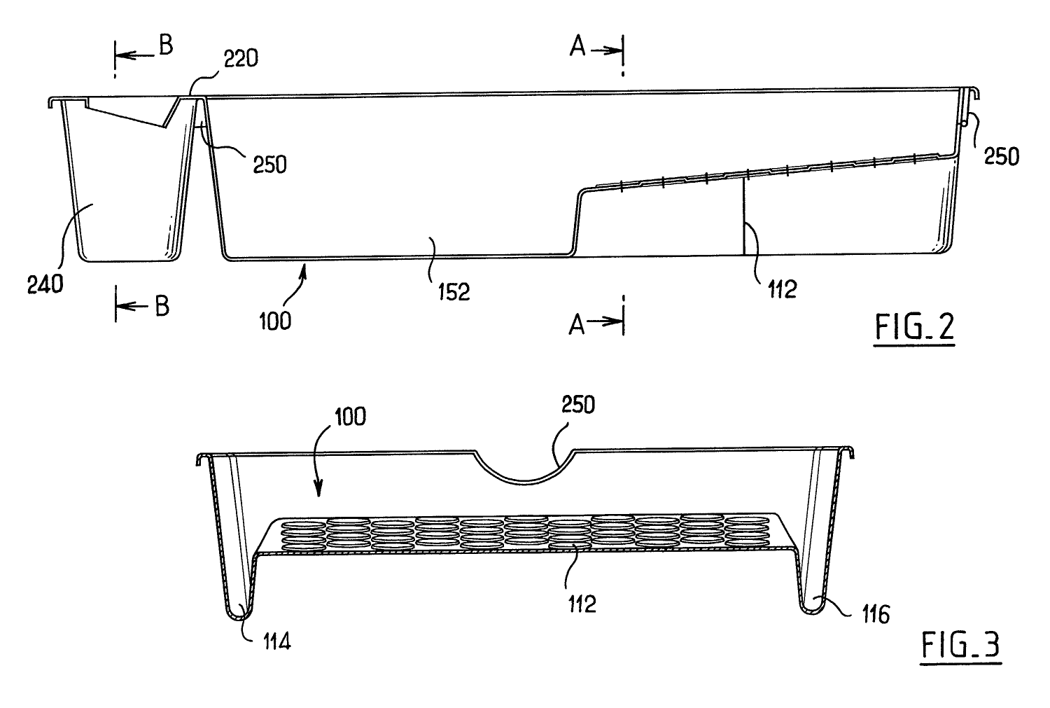

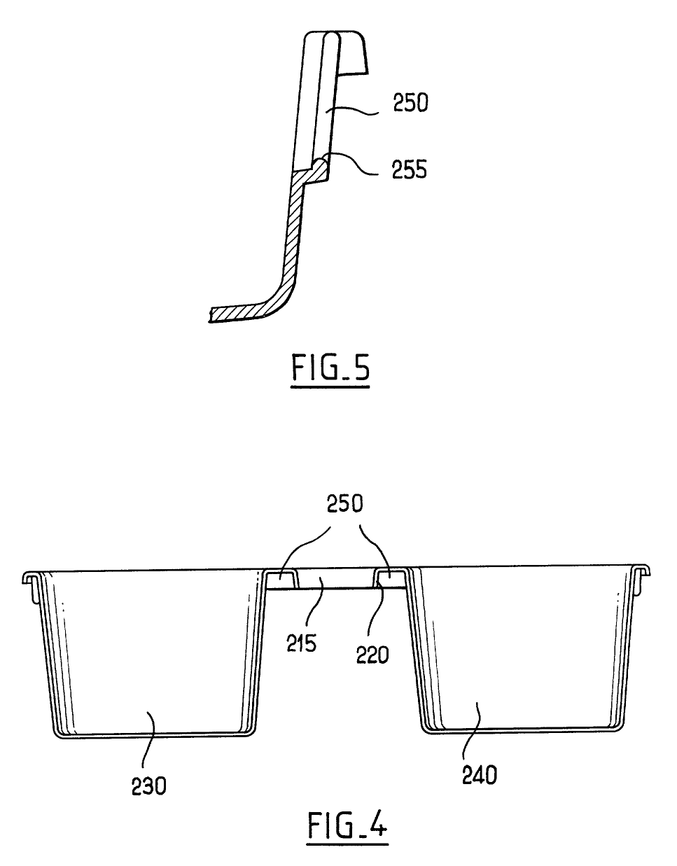

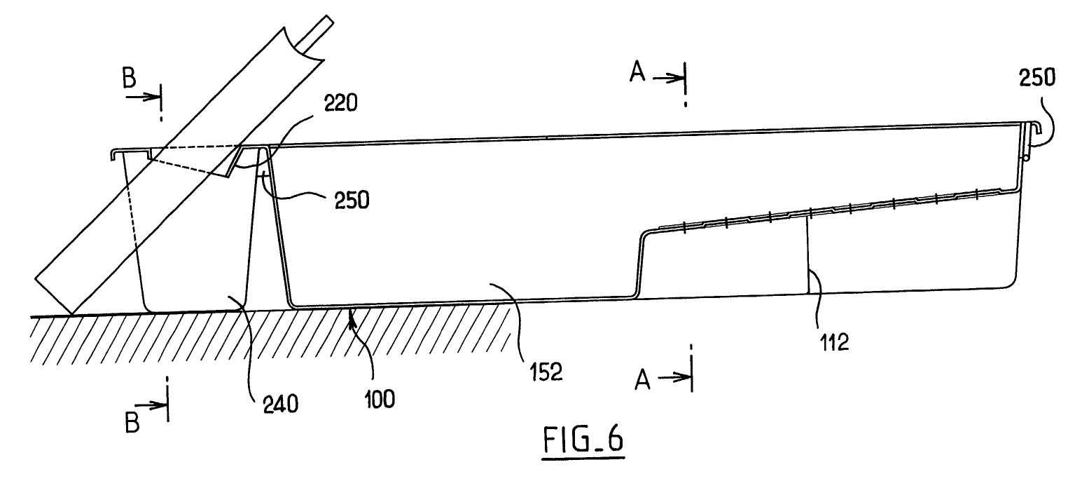

### MORE DETAILED DESCRIPTION

The present tray is a one-piece molded tray comprising mainly a pan 100 and means for holding the roller when not in use. The pan 100 is made up of two halves 110 and 150 respectively forming a paint spreading slope 112 and a paint trough 152 extending from the bottom of the slope.

The pan 100 is rectangular in shape, being bordered by four substantially vertical walls. The wall that is on the side of the trough 152 that is remote from the slope 112 is extended out from the trough by an arrangement 200 for holding paint brushes and rollers.

In this example, the arrangement 200 extends over the entire width of the pan 100, with its top portion extending horizontally level with the tops of the walls of the pan 100.

In its central portion, the arrangement has a horizontal wall 210 lying in the horizontal plane of the top edges of the pan 100. This horizontal wall 210 has a central orifice 215 with the outline of the orifice being extended downwards so as to form a circumferential wall 220 extending transversely to the general plane of the tray.

On either side of this vertical passage 215, the holding arrangement has two paint brush wells 230 and 240 which are described below.

The circumferential wall 220 is substantially frustoconical in shape on an axis that slopes relative to the vertical of the tray, tilting towards the pan 100. The bottom edge of this circumferential wall 220 lies in a plane that slopes towards the pan 100.

In horizontal section, the passage 215 presents an area that is sufficient to receive the handle of a roller and to leave angular clearance for the handle to tilt towards and away from the pan 100.

Once the handle has been inserted downwards into the passage 215, it bears against two opposite edges of the passage 215, specifically the top edge of the circumferential wall 220 where it is closest to the pan 100, and the opposite bottom edge of the circumferential wall 220 where it is furthest from the pan 100.

In cross-section relative to the passage 215, i.e. relative to the handle, the circumferential wall 220 has a concave portion 217 that is open towards the handle and the pan 100. The bottom edge of the wall 220 against which the handle comes to bear thus likewise presents a concave portion facing towards the pan 100.

In the present embodiment, the opposite bearing edge, i.e. the top edge of the wall 220 where it comes closest to the pan 100, is substantially rectilinear and parallel to the adjacent wall of the pan 100.

Nevertheless, this bearing edge could likewise be concave relative to the handle.

Because of the concave shape 217 adopted in this way, the handle takes up a stable position in the center of the bearing edge furthest from the pan 100, thus preventing the handle from sliding sideways relative to the general shape of the tray.

In this embodiment, the concave portion 217 presents an angle of about 120° with a rounded tip.

The portion of the wall 220 which is furthest from the pan 100 extends downwards a short distance only so as to allow the handle to project obliquely with its bottom end remote from the pan 100.

Furthermore, the extent to which the circumferential wall 220 extends downwards decreases going away from the pan. Thus, its bearing edge is higher the further away it is from the pan. This bearing edge extends obliquely relative to the horizontal going away from the pan 100, so that in its region furthest from the pan it forms a recess that is directed upwardly relative to the horizontal, with the handle of the roller coming to bear in stable manner in this recess.

The roller thus occupies a position in which its roller proper is higher than its handle.

The user can choose to engage the handle until it comes to bear against the surface on which the tray is standing, or the handle can be left positioned against the above-described bearing edges without coming into contact with the surface on which the tray is standing.

By turning the handle appropriately, the user can place the roller so that its axis extends horizontally or else so that it is tilted down towards the pan.

In its portion closest to the pan 100, the circumferential wall 220 extends obliquely towards the inside of the passage 215 so that it tends to guide the bottom end of the roller handle away from the pan 100 while it is being inserted into the passage 215.

Once the user has let go the handle, it therefore naturally comes to bear against the circumferential wall 220 of the passage 215 via the top edge of its portion closest to the pan, and its bottom edge furthest from the pan.

The roller thus naturally tends to take up a sloping position with its high portion (the paint-filled roller proper) sloping over the pan 100 (at a distance from the bottom thereof) without any risk of it tilting towards the outside of the tray, which would have the unwanted effect of allowing the roller to drip outside the tray and could even destabilize the tray.

On either side of the passage 215, each of the wells 230 and 240 is rectangular in shape, occupying about one-third of the end wall of the pan 100. Each well is of a depth equal to the height of the tray, thus enabling it to hold in stable manner a paint brush inserted in a bristles-down position.

Respective stiffeners 250 connect a wall of each well 230 and 240 to the circumferential wall 220 of the passage 215. Similarly, a stiffener 250 extends from the circumferential wall 220 to connect it to an adjacent end wall of the pan 100.

The slope 112 is formed by a projecting portion of the bottom of the pan 100. On either side of the slope 112, it is bordered along the sides of the pan 100 by gutters 114 and 116 formed merely by respective corrugations extending parallel to the longitudinal axis of the pan.

Thus, any paint running over the sides of the slope 112 slides into the gutters 114 and 116 whose bottoms are level with the bottom of the paint trough 152.

The slope 112 is provided with elements in relief so as to cause the roller proper to rotate, thereby spreading paint effectively in uniform manner over the roller, with the elements in relief being implemented in this case by rounded indentations projecting alternately upwards and downwards relative to the tray.

At its end furthest from the arrangements 200 for holding a roller and paint brushes, the tray has a semicircular cutout 250 that is upwardly open and that is of diameter slightly greater than that of a conventional roller.

This cutout 250 is designed to scrape the roller proper so as to remove paint therefrom before it is cleaned and put away, thereby considerably reducing the volume of solvent required for cleaning the roller.

This cutout 250 is defined by a rounded rim 255 integrally molded with the tray, the rim 255 being offset a little towards the outside of the wall and projecting slightly into the cutout 250 so as to scrape the roller effectively without damaging it.

The bottom edge of the cutout 250 is higher than the top edge of the slope 112.

Thus, scraped-off paint flows down onto the slope 112 to return subsequently to the paint trough.

1. A paint tray for a paint roller, the tray comprising a paint pan and holding arrangements for a roller comprising a handle and a rotary roller proper, the holding arrangements being provided to hold the roller in a selected position in which at least the lowest portion of the roller proper is in a position to drip into the paint pan, wherein the holding arrangements are designed to co-operate essentially with the handle of the roller.

2. A paint tray according to claim 1, wherein the holding arrangements include two bearing edges secured to the tray and spaced apart from each other going away from the paint pan by a distance that is sufficient to allow the handle of the roller to be received between them.

3. A paint tray according to claim 1, wherein the holding arrangements are designed to hold a roller in a position that slopes relative to the vertical and in which the roller proper is higher than its handle.

4. A paint tray according to claim 2, wherein the tray forms a passage having a surrounding wall constituting said bearing edges.

5. A paint tray according to claim 2, wherein one of the bearing edges is concave towards the other bearing edge.

6. A paint tray according to claim 2, wherein one of said bearing edges extends at least in part obliquely relative to the horizontal so as to form a recess going away from a horizontal plane such that handle of a roller comes to bear in said recess of the edge.

7. A paint tray according to claim 2, wherein the bearing edges are placed so as to allow the handle to bear simultaneously against two edges and against a surface on which the tray is standing.

8. A paint tray according to claim 4, having a wall surrounding the passage at least in part, and extending substantially in a handle-insertion direction.

9. A paint tray according to claim 8, wherein the wall surrounding at least of the passage is oriented obliquely relative to the vertical.

10. A paint tray according to claim 4, wherein, on either side of the passage, the tray forms two wells other than said paint pan.

11. A paint tray according to claim 1, having a wall forming a substantially cylindrical cutout for scraping the roller.

12. A paint tray according to claim 11, wherein the tray has a sloping wall for rolling the roller, and wherein the cutout for scraping the roller is formed in a wall adjacent to the highest portion of the slope.
